(19) United States
(12) Patent Application Publication
(10) Pub. No.: US 2020/0109249 A1
(43) Pub. Date: Apr. 9, 2020

(54) Methods for Producing Polyurethane Foams

(71) Applicant: Dow Global Technologies LLC, Midland, MI (US)

(72) Inventors: Vanni Parenti, Correggio (IT); Sara Cavalca, Correggio (IT); Thomas Mosciatti, Correggio (IT); Ernesto Di Maio, Napoli (IT); Maria Rosaria Di Caprio, Napoli (IT); Cosimo Brondi, Angri - Salerno (IT); Salvatore Iannace, Milano (IT)

(73) Assignee: Dow Global Technologies LLC, Midland, MI (US)

(21) Appl. No.: 16/590,751

(22) Filed: Oct. 2, 2019

(30) Foreign Application Priority Data
Oct. 3, 2018 (IT) 102018000009122

(51) Int. Cl. C08J 9/12; C08J 9/14

(52) U.S. Cl. CPC C08J 9/122; C08J 9/141; C08J 2205/044; C08J 2375/04; C08J 2205/042; C08J 9/146

(57) ABSTRACT

Processes for producing a polyurethane foam described herein include mixing a physical blowing agent with one or more of an isocyanate-reacting mixture and an isocyanate at a sorption pressure pₛₒᵣₚ for a time tₛₒᵣₚ, reacting the isocyanate-reacting mixture and the isocyanate at a pressure p₁ for a time t₁, reducing the pressure to a pressure p₂, maintaining the pressure at the pressure p₂ for a time t₂, and reducing the pressure to atmospheric pressure pₐₜₘ. In various embodiments, pₐₜₘ<p₂<pₛₐₜ<pₛₒᵣₚ and pₛₐₜ<p₁, where pₛₐₜ is a saturation pressure for the physical blowing agent.

### CROSS-REFERENCE TO RELATED APPLICATIONS

This application claims priority to Italian Patent Application 102018000009122, filed Oct. 3, 2018, which is incorporated by reference herein in its entirety.

### FIELD

Embodiments of the present disclosure are generally related to methods for producing polyurethane foams, and are more specifically related to methods for producing polyurethane foams using various controlled pressure release steps.

### BACKGROUND

Regulations surrounding thermal insulation in various sectors are becoming increasingly strict. Although foamed materials, such as rigid polyurethane foams, having a thermal conductivity of less than 18 mW/m-K may be used in thermal insulation as a way to comply with the regulations and take advantage of good insulation capacity of some gases, many of the gases used as blowing agents in the preparation of these foamed materials are known to have high ozone depletion potential (ODP) or global warming potential (GWP), and their use is limited by the Montreal Protocol.

Accordingly, there is a need for alternative methods for producing polyurethane foams with reduced ozone depletion potential (ODP) and/or global warming potential (GWP) combined with an improved thermal insulation properties.

### SUMMARY

Embodiments of the present disclosure meet this need by utilizing processes to achieve polyurethane foams with reduced ozone depletion potential (ODP) and/or global warming potential (GWP) and/or with improved thermal insulation properties through a micro and/or nano cellular foam structure. According to one or more embodiments herein, a process for producing a polyurethane foam includes mixing a physical blowing agent with one or more of an isocyanate-reacting mixture and an isocyanate at a sorption pressure pₛₒᵣₚ for a time tₛₒᵣₚ, reacting the isocyanate-reacting mixture and the isocyanate at a pressure p₁ for a time t₁, reducing the pressure to a pressure p₂, maintaining the pressure at the pressure p₂ for a time t₂, and reducing the pressure to atmospheric pressure pₐₜₘ. In various embodiments, pₐₜₘ<p₂<pₛₐₜ<pₛₒᵣₚ, and Pₛₐₜ<p₁, where pₛₐₜ is a saturation pressure for the physical blowing agent.

### BRIEF DESCRIPTION OF THE DRAWINGS

FIG. 1A shows an Scanning Electron Microscope (SEM) image of the foam of Example 1 prepared in accordance with one or more embodiments described herein;

FIG. 1B shows an SEM image of the foam of Comparative Example A prepared according to current available state of the art techniques;

FIG. 1C shows an SEM image of the foam of Example 2 prepared in accordance with one or more embodiments described herein;

FIG. 1D shows an SEM image of the foam of Comparative Example B prepared according to current available state of the art techniques;

FIG. 2A shows an SEM image of the foam of Example 2 prepared in accordance with one or more embodiments described herein;

FIG. 2B shows an SEM image of the foam of Example 6 prepared in accordance with one or more embodiments described herein; and

FIG. 2C shows an SEM image of the foam of Example 7 prepared in accordance with one or more embodiments described herein.

### DETAILED DESCRIPTION

In various embodiments described herein, a process for producing a polyurethane foam includes mixing a physical blowing agent with one or more of an isocyanate-reacting mixture and an isocyanate at a sorption pressure pₛₒᵣₚ for a time tₛₒᵣₚ, reacting the isocyanate-reacting mixture and the isocyanate at a pressure p₁ for a time t₁, reducing the pressure to a pressure p₂, maintaining the pressure at the pressure p₂ for a time t₂, and reducing the pressure to atmospheric pressure pₐₜₘ. In various embodiments, pₐₜₘ<p₂<pₛₐₜ<pₛₒᵣₚ and pₛₐₜ<p₁, where pₛₐₜ is a saturation pressure for the physical blowing agent. In particular, pₛₐₜ is the pressure of the gas phase in equilibrium with the polymer/gas solution at the final gas weight fraction achieved in sorption at specific processing temperature. Such embodiments enable the use of an environmentally-friendly blowing agent, such as CO₂, while multiple de-pressurization steps enable fine-tuning of the properties of the resultant foam, as will be described in greater detail below.

As used herein, the term “polyurethane” encompasses polyurethane, polyurethane/polyurea, and polyurethane/polyisocyanurate materials. In various embodiments, the polyurethane foam layer may be formed from a polymer matrix formed by reacting an isocyanate-reacting mixture with an isocyanate.

The isocyanate-reacting mixture includes one or more polyols. In some embodiments, the isocyanate-reacting mixture includes at least one polyester polyol. Various molecular weights are contemplated for the polyester polyol. The polyester polyol may contain multiple ester groups per molecule and have an average of at least 1.5 hydroxyl groups per molecule, at least 1.8 hydroxyl groups per molecule, or at least 2 hydroxyl groups per molecule. It may contain up to 6 hydroxyl groups per molecule in some embodiments, but, in other embodiments, will contain up to about 3 hydroxyl groups per molecule. The hydroxyl equivalent weight of the polyester polyol can range from about 75 to 4000 or from 150 to 1500.

Suitable polyester polyols include reaction products of hydroxylated compounds, for example diols, with polycarboxylic acids or their anhydrides, such as dicarboxylic acids or dicarboxylic acid anhydrides. The polycarboxylic acids or anhydrides may be aliphatic, cycloaliphatic, aromatic and/or heterocyclic and may be substituted, such as with halogen atoms. The polycarboxylic acids may be unsaturated. Examples of these polycarboxylic acids include succinic acid, adipic acid, terephthalic acid, isophthalic acid, trimellitic anhydride, phthalic anhydride, maleic acid, maleic acid anhydride and fumaric acid. The hydroxylated compounds used in making the polyester polyols may have an equivalent weight of 150 or less, 140 or less, or 125 or less, and include ethylene glycol, 1,2- and 1,3-propylene glycol, 1,4- and 2,3-butane diol, 1,6-hexane diol, 1,8-octane diol, neopentyl glycol, cyclohexane dimethanol, 2-methyl-1,3-propane diol, glycerin, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol, polyethylene glycol, and the like.

In some embodiments, the isocyanate-reacting mixture includes at least one polyether polyol. Various molecular weights are contemplated for the polyether polyol. The polyether polyol may be derived from one or more alkylene oxides such as propylene oxide, ethylene oxide, and/or butylene oxide, as would be understood by a person of ordinary skill in the art. For example, the polyether polyol may be prepared by reacting the one or more alkylene oxides with one or more initiators having from 2 to 10 active hydrogens, in the presence of a polymerization catalyst. Examples of suitable initiators include ethylene glycol, diethylene glycol, propylene glycol, dipropylene glycol, tripropylene glycol, 1,4-butanediol, 1,6-hexane diol; cycloaliphatic diols such as 1,4-cyclohexane diol, glycerine, trimethanol propane, triethanolamine, sucrose, sorbitol and toluenediamine.

The polyether polyol may have a number average molecular weight of from about 200 g/mol to about 15,000 g/mol. In some embodiments, the molecular weight is greater than about 400 g/mol or greater than about 1000 g/mol. In other embodiments, the molecular weight may be less than about 15000 g/mol, less than about 10,000 g/mol, or less than about 9,000 g/mol. Accordingly, in some embodiments, the polyether polyol has a molecular weight of from about 425 g/mol to about 8500 g/mol or from about 450 g/mol to about 4000 g/mol. Examples of suitable polyether polyols include, but are not limited to, those commercially available under the trademark VORAPEL™, those commercially available under the trademark VORANOL™, such as VORALUX™ HF505, VORANOL™ 8000LM, VORANOL™ 4000LM, VORANOL™ 1010L, VORANOL™ CP 1055, and VORANOL™ CP 260, and those commercially available as Polyglycol P-2000 and Polyglycol P-425, all available from The Dow Chemical Company (Midland, Mich.).

As used herein, a hydroxyl number is the milligrams of potassium hydroxide equivalent to the hydroxyl content in one gram of the polyol or other hydroxyl compound. In some embodiments, the resultant polyether polyol has a hydroxyl number of from about 10 mg KOH/g to about 700 mg KOH/g. In still other embodiments, the resultant polyether polyol has a hydroxyl number of from about 275 mg KOH/g to about 400 mg KOH/g. The polyether polyol may have a nominal hydroxyl functionality of from about 2 or greater (e.g., from 2 to 6, from 2 to 5, from 2 to 4, or 2). The polyether polyol may have an average overall hydroxyl functionality of from about 2 to about 8 (e.g., 2 to 3.5). As used herein, the hydroxyl functionality (nominal and average overall) is the number of isocyanate reactive sites on a molecule, and may be calculated as the total number of moles of OH over the total number of moles of polyol.

Other types of polyols may be used in addition to those provided above. For example, aromatic or aliphatic polyether polyols, aliphatic or aromatic polyether-carbonate polyols, aliphatic or aromatic polyether-ester polyols, and polyols obtained from vegetable derivatives may be used. Accordingly, various combinations of polyols may be used to form the isocyanate-reacting mixture. For example, other example polyols include VORANOL™ RN490, VORANOL™ RH360, VORANOL™ RN482, and TERCAROL™ 5903, all available from The Dow Chemical Company (Midland, Mich.).

Other additives, such as chain extenders, flame retardants, cross-linkers, fillers, and the like may also be included. Example chain extenders include dipropylene glycol, tripropylene glycol, diethyleneglycol, polypropylene, and polyethylene glycol.

The flame retardant may be a solid or a liquid, and include a non-halogenated flame retardants, a halogenated flame retardant, or combinations thereof. Example flame retardants include, by way of example and not limitation, melamine, expandable graphite, phosphorous compounds with or without halogens, aluminum containing compounds, magnesium based compounds, nitrogen based compounds with or without halogens, chlorinated compounds, brominated compounds, and boron derivatives.

In certain embodiments the reaction mixture for forming the polyurethane foam may include a filler. Suitable fillers may be selected from the families of inorganic compounds such as calcium carbonate or of polymeric materials such as polyethylene, polyamide or polytetrafluoroethylene.

The isocyanate may include isocyanate-containing reactants that are aliphatic, cycloaliphatic, alicyclic, arylaliphatic, and/or aromatic isocyanates and derivatives thereof. Derivatives may include, by way of example and not limitation, allophanate, biuret, and NCO-terminated prepolymers. According to some embodiments, the isocyanate includes at least one aromatic isocyanate (e.g., at least one aromatic polyisocyanate). For example, the isocyanate may include aromatic diisocyanates such as at least one isomer of toluene diisocyanate (TDI), crude TDI, at least one isomer of diphenyl methylene diisocyanate (MDI), crude MDI, and/or higher functional methylene polyphenol polyisocyanate. As used herein, MDI refers to polyisocyanates selected from diphenylmethane diisocyanate isomers, polyphenyl methylene polyisocyanates, and derivatives thereof bearing at least two isocyanate groups. The crude, polymeric, or pure MDI may be reacted with polyols or polyamines to yield modified MDI. Blends of polymeric and monomeric MDI may also be used. In some embodiments, the MDI has an average of from 2 to 3.5 (e.g., from 2 to 3.2) isocyanate groups per molecule. Example isocyanate-containing reactants include those commercially available under the tradename VORANATE™ from The Dow Chemical Company (Midland, Mich.), such as VORANATE™ M229 PMDI isocyanate (a polymeric methylene diphenyl diisocyanate with an average of 2.7 isocyanate groups per molecule).

A catalyst may also be included in the composition forming the polyurethane foam layer. Example catalysts that may be used include gelling and blowing catalysts (such as POLYCAT™ 8 and POLYCAT™ 5) or trimerisation catalysts, which promote reaction of isocyanate with itself, such as tris(dialkylaminoalkyl)-s-hexahydrotriazines (such as 1,3,5-tris(N,N-dimethylaminopropyl)-s-hexahydrotriazine, DABCO™ TMR 30, DABCO™ K-2097 (potassium acetate), DABCO™ K15 (potassium octoate), POLYCAT™ 41, POLYCAT™ 43, POLYCAT™ 46, DABCO™ TMR, CURITHANE™ 52, tetraalkylammonium hydroxides (such as tetramethylammonium hydroxide), alkali metal hydroxides (such as sodium hydroxide), alkali metal alkoxides (such as sodium methoxide and potassium isopropoxide), and alkali metal salts of long-chain fatty acids having 10 to 20 carbon atoms (and in some embodiments, pendant hydroxyl groups).

The polyurethane foam may further include a cell opening surfactant, which may be employed to control the percentage of open-cell versus closed-cell in the polyurethane foam. In various embodiments, the cell opening surfactant is a silicone-based surfactant. Suitable commercially available surfactants include, by way of example and not limitation, KRYTOX™ GPL-105 and KRYTOX™ GPL-100 (available from E.I. du Pont de Nemours and Company), MATESTAB™ AK-9903 (available from Jiangsu Maysta Chemical Co. Ltd.) and Niax Silicone L-6164 (available from Momentive).

In various embodiments, the polyurethane foam includes a physical blowing agent. As used herein, “physical blowing agents” are low-boiling liquids which volatilize under the curing conditions to form the blowing gas. Exemplary physical blowing agents include HFC(g)s such as methyl fluoride, difluoromethane (HFC-32), perfluoromethane, ethyl fluoride (HFC-161), 1,1-difluoroethane (HFC-152a), 1,1,1-trifluoroethane (HFC-143a), 1,1,2,2-tetrafluoroethane (HFC-134), 1,1,1,2-tetrafluoroethane (HFC-134a), pentafluoroethane (HFC-125), perfluoroethane, 2,2-difluoropropane (HFC-272fb), 1,1,1-trifluoropropane (HFC-263fb), and 1,1,1,2,3,3,3-heptafluoropropane (HFC-227ea); HFOs (hydrofluorolefins) such as 1-Chloro-3,3,3-trifluoropropene and 1,1,1,4,4,4-Hexafluorobut-2-ene; inorganic gases such as argon, nitrogen, oxygen, and air; and linear, branched, or cyclic alkanes or fluoroalkanes having 1-6 carbons. Other physical blowing agents are contemplated, provided they can be sorbed in an isocyanate-reacting mixture and/or isocyanate.

The blowing agent employed may include carbon dioxide added as a gas or a liquid, or advantageously generated in-situ by the reaction of water with polyisocyanate, optionally in combination with a physical co-blowing agent. Carbon dioxide may also be chemically obtained by other means including the amine/carbon dioxide complexes such as disclosed in U.S. Pat. Nos. 4,735,970 and 4,500,656, the full disclosures of which are hereby incorporated by reference in their entireties, for use as a blowing agent. Carbon dioxide (CO₂) is considered eco-friendly and safe, with zero ODP and the lowest GWP among known blowing agents. In addition, high-pressure CO₂ foaming may be effective for producing thermoplastic polymers with desirable cell sizes, such as may be required for producing microcellular and nanocellular foams. Other suitable blowing agents include, for example, volatile alkanes such as pentane, hexane or halogen-containing substances such as fluorocarbons and the hydrogen-containing chlorofluorocarbon compounds.

The physical blowing agent is not particularly limited. However, in various embodiments, the physical blowing agent includes CO₂ or a blend of CO₂ and N₂. In some embodiments, the blowing agent is or includes supercritical CO₂. In other embodiments, the physical blowing agent includes at least 80 wt % CO₂. The blowing agent is present in an amount of from about 0.5 to about 25, preferably from about 5 to about 15 parts per 100 parts by weight of polyol.

According to various embodiments, the physical blowing agent is mixed with the isocyanate-reacting mixture and/or the isocyanate at a sorption pressure pₛₒᵣₚ for a time tₛₒᵣₚ. The sorption pressure pₛₒᵣₚ is the pressure at which sorption of the physical blowing agent onto the polyol and/or isocyanate occurs. In various embodiments, pₛₒᵣₚ is greater than or equal to 1 bar and less than or equal to 200 bar, or greater than or equal to 40 bar and less than or equal to 150 bar.

The time tₛₒᵣₚ may vary depending on the particular blowing agent employed, the polymer chemistry, and the mixing system, and, in general, may be from greater than or equal to one minute to less than or equal to 48 hours. In some embodiments, such as embodiments in which the blowing agent is CO₂, tₛₒᵣₚ may be from greater than or equal to 2 hours to less than or equal to 25 hours.

After sorption of the blowing agent, the isocyanate-reacting mixture and the isocyanate are reacted at a pressure p₁ for a time t₁. The pressure p₁ may be the same as pₛₒᵣₚ (i.e., p₁=pₛₒᵣₚ), or the pressure p₁ may be different than pₛₒᵣₚ. In various embodiments, the pressure p₁ is greater than a saturation pressure pₛₐₜ for the physical blowing agent (i.e., pₛₐₜ<p₁).

The saturation pressure pₛₐₜ for the physical blowing agent may vary depending on: the particular blowing agent and its sorbed quantity; the polyurethane component chemistry; and the sorption temperature. Generally, pₛₐₜ may be greater than atmospheric pressure pₐₜₘ and may be greater than or equal to 1 bar and less than or equal to 150 bar, greater than or equal to 2 bar and less than or equal to 50 bar, or even greater than or equal to 3 bar and less than or equal to 20 bar. In embodiments in which the blowing agent is CO₂, pₛₐₜ may be from greater than or equal to 2 bar and less than or equal to 50 bar. Accordingly, in various embodiments, pₐₜₘ<pₛₐₜ<pₛₒᵣₚ.

In general, p₁ may be greater than or equal to 1 bar and less than or equal to 200 bar. In embodiments, p₁ is less than 200 bar. The time t₁ may vary depending on polymer reactivity. In various embodiments, t₁ is greater than or equal to 0.1 min and less than or equal to 60 min, or greater than or equal to 3 minutes and less than or equal to 40 minutes. In some particular embodiments, t₁ is less than or equal to 25 minutes. It is contemplated that the reacting of the isocyanate-reacting mixture and the isocyanate may be carried out in any suitable apparatus known and used in the art.

Following reaction of the polyurethane components (e.g., the isocyanate-reacting mixture and the isocyanate), the pressure is reduced to a pressure p₂. In various embodiments, the controlled pressure release to p₂ may coincide with the injection of the polyurethane into a cavity or mold kept at the pressure p₂. The pressure p₂ is less than the pressure p₁ (i.e., p₂<p₁), less than the saturation pressure pₛₐₜ (i.e., p₂<pₛₐₜ), and different from (e.g., greater than) atmospheric pressure pₐₜₘ. Accordingly, in various embodiments, pₐₜₘ<p₂<pₛₐₜ. In various embodiments, p₂ is greater than or equal to 0.5 bar and less than or equal to 149 bar, or greater than 2.5 bar and less than or equal to 50 bar. According to various embodiments, the pressure may be reduced from p₁ to p₂ at a rate of from greater than or equal to 50 bar/s to less than or equal to 50,000 bar/s, or from greater than or equal to 500 bar/s to less than or equal to 5,000.

In various embodiments, the pressure p₂ is maintained for a time t₂, during which time the reaction continues to progress. In particular, the nucleation process may occur at pressure p₂ during time t₂. The time t₂ depends on the polymer reactivity and may be greater than or equal to 0.1 minute and less than or equal to 60 minutes, or even greater than or equal to 0.1 minute and less than or equal to 5 minutes.

Finally, the pressure is reduced to atmospheric pressure pₐₜₘ. In various embodiments, the pressure is reduced to atmospheric pressure pₐₜₘ at a controlled rate. The rate may be from 0.5 bar/minute to 10 bar/minute and, in some embodiments, may vary during the depressurization step varying in the range. Without being bound by theory, it is believed that the rate at which the pressure of the system is reduced to atmospheric pressure may be selected to guide cell growth concurrent to polyurethane curing. For example, the gas, available after sorption, is hindered from inflating the bubbles on a weak (e.g., not fully-cured) polyurethane polymer by pressure which compresses the gas. As the reaction continues and the pressure is released in a controlled manner, the pressure is progressively reduced, which increases the gas volume and the bubble size. Accordingly, the rate of pressure reduction can vary depending on the cure rate of the polymer and the desired cell size.

Accordingly, in various embodiments, one or more of the pressures, temperatures, and rates of change in the process may be selected to produce a polyurethane foam having one or more desired properties. In various embodiments, the polyurethane foam has a thermal conductivity of less than or equal to 18 mW/m-K, or less than or equal to 16 mW/m-K at 10° C. For example, the polyurethane foam may have a thermal conductivity greater than or equal to 6 mW/m-K and less than or equal to 18 mW/m-K or greater than or equal to 6 mW/m-K and less than or equal to 16 mW/m-K at 10° C.

In various embodiments, the resultant polyurethane foam may have a density of less than 450 kg/m³ according to ISO 2781. For example, the polyurethane foam may have an overall density of from 30 kg/m³ to 450 kg/m³, or from 40 kg/m³ to 120 kg/m³ according to the water method of ISO 2781.

The polyurethane foam, in various embodiments, has a porosity of at least 70%. For example, the polyurethane foam may have a porosity of from 70% to 99%, or from 85% to 98%. Unless otherwise specified, the porosity is calculated by evaluating the difference between the density of the unexpanded material with the obtained foam.

According to various embodiments, the polyurethane foam has a cell size that is less than about 60 μm. For example, in embodiments, the polyurethane foam has a cell size of greater than or equal to 10 μm and less than or equal to 60 μm. However, other cell sizes, including cell sized larger than 60 μm are contemplated, depending on the particular application in which the polyurethane foam is to be employed. Accordingly, in some embodiments, the polyurethane foam may have a microcellular structure with cells smaller than 10 μm. In some embodiments, the polyurethane foam may have a nanocellular structure with cells smaller than 1 μm.

### EXAMPLES

The following examples are provided to illustrate various embodiments, but are not intended to limit the scope of the claims. All parts and percentages are by weight unless otherwise indicated. Approximate properties, characters, parameters, etc., are provided below with respect to various working examples, comparative examples, and the materials used in the working and comparative examples. Further, a description of the raw materials used in the examples is as follows:

VORANOL™ RN 482 is a polyether polyol available from The Dow Chemical Company (Midland, Mich.);

VORANOL™ RN 490 is a polyether polyol available from The Dow Chemical Company (Midland, Mich.);

VORANOL™ CP 1055 is a polyether polyol available from The Dow Chemical Company (Midland, Mich.);

VORANOL™ CP 1421 is a polyether polyol available from The Dow Chemical Company (Midland, Mich.);

TERCAROL™ 5903 is a polyether polyol available from The Dow Chemical Company (Midland, Mich.);

VORANOL™ CP 260 is a polyether polyol available from The Dow Chemical Company (Midland, Mich.);

MATESTAB™ AK-8850 is a silicone surfactant available from Soo Kyung Chemical Co. (Korea);

NIAX™ L-6164 is an additive available from Momentive Performance Materials, Inc. (Waterford, N.Y.);

POLYCAT™ 5 is a pentamethyl diethylene triamine catalyst available from Evonik Industries;

POLYCAT™ 8 is a tertiary amine catalyst available from Evonik Industries; and

VORACOR™ CR 761 is a polymeric methylene diphenyl di-isocyanate (PMDI) available from The Dow Chemical Company (Midland, Mich.).

Two isocyanate-reacting mixtures, Polyol 1 and Polyol 2, were prepared for use in the examples. The formulations for Polyol 1 and Polyol 2 are provided in wt % in Table 1 below.

TABLE 1
Table 1: Polyol Formulations

| | Polyol 1 | Polyol 2 |
|---|---|---|
| VORANOL™ RN | 29 wt % | 0 |
| 482 | | |
| VORANOL™ RN | 29 wt % | 0 |
| 490 | | |
| VORANOL™ CP | 8 wt % | 43.6 wt % |
| 1055 | | |
| TERCAROL™ | 29 wt % | 9.2 wt % |
| 5903 | | |
| VORANOL™ CP | 0 | 36 wt % |
| 260 | | |
| VORANOL™ CP | 0 | 9.2 wt % |
| 1421 | | |
| MATESTAB™ | 2 wt % | 0 |
| AK-8850 | | |
| NIAX™ L-6164 | 0 | 2 wt % |
| POLYCAT™ 5 | 0.5 wt % | 0.5 wt % |
| POLYCAT™ 8 | 2 wt % | 0.9 wt % |
| POLYCAT™ 41 | 0.5 wt % | 0.5 wt % |
| Water | <0.3 wt % | <0.3 wt % |
| Viscosity at 25° C. | 15,000 | 755 |
| (mPas) | | |
| Specific gravity | 1.08 | 1.05 |
| (25° C.) | | |

Comparative Examples A and B and Examples 1-7 were prepared by sorbing the blowing agent onto the polyol and isocyanate separately at amounts to reach pₛₒᵣₚ for time tₛₒᵣₚ. After sorption, the isocyanate-reacting mixture and isocyanate were reacted at p₁ for time t₁. The pressure was then reduced to pressure p₂, and maintained at pressure p₂ for time t₂. The pressure was then reduced to atmospheric pressure pₐₜₘ. Process conditions are reported in Table 2.

TABLE 2
Polyurethane Reaction Process Conditions

| | Comp. | Comp. | | | | | | | |
|---|---|---|---|---|---|---|---|---|---|
| | Ex. A | Ex. B | Ex. 1 | Ex. 2 | Ex. 3 | Ex. 4 | Ex. 5 | Ex. 6 | Ex. 7 |
| Polyol 1 | 100 | 0 | 100 | 0 | 0 | 0 | 0 | 0 | 0 |
| Polyol 2 | 0 | 100 | 0 | 100 | 100 | 100 | 100 | 100 | 100 |
| VORACOR ™ | 119 | 72 | 119 | 72 | 72 | 72 | 72 | 72 | 72 |
| CR 761 | | | | | | | | | |
| Blowing Agent | CO₂ | CO₂ | CO₂ | CO₂ | CO₂ | CO₂ | CO₂ | CO₂/N₂ | N₂ |
| | | | | | | | | (20/80) | |
| pₛₒᵣₚ (bar) | 60 | 40 | 60 | 40 | 40 | 40 | 40 | 150 | 120 |
| tₛₒᵣₚ (br) | 3 | 3 | 3 | 3 | 3 | 3 | 3 | 3 | 3 |
| pₛₐₜ (bar) | 20 | 7.18 | 20 | 7.18 | 7.18 | 7.18 | 7.18 | — | — |
| p₁ (bar) | 60 | 40 | 60 | 40 | 40 | 40 | 40 | 150 | 120 |
| t₁ (min) | 3.7 | 12 | 3.7 | 12 | 21 | 27 | 27 | 10 | 12 |
| p₂ (bar) | 0 | 0 | 7.6 | 3.5 | 3.5 | 3.5 | 3.5 | 15.8 | 12.5 |
| t₂ (min) | 0 | 0 | 3 | 3 | 3 | 3 | 3 | 3 | 3 |
| Pressure drop | 1 | 1 | 1 | 1 | 1 | 1 | 1 | 1 | 1 |
| rate (bar/min) | | | | | | | | | |

Various properties of the resultant polyurethane foams were measured. Cell size was measured using scanning electron microscope (SEM) images elaborated with PORE!SCAN™ software available from Goldlücke GmbH (Germany). Density was measured according to the ISO 2781 method. Open cell content was measured according to the ASTM D 6226 method. The results are reported in Table 3.

TABLE 3
Polyurethane Foam Properties

| | Comp. | Comp. | | | | | | | |
|---|---|---|---|---|---|---|---|---|---|
| | Ex. A | Ex. B | Ex. 1 | Ex. 2 | Ex. 3 | Ex. 4 | Ex. 5 | Ex. 6 | Ex. 7 |
| Cell size, ave. ± | 200 ± 25 | 56 ± 30 | 29 ± 12 | 15 ± 3 | 108 ± 28 | 122 ± 40 | 100 ± 32 | 4.4 ± 1.1 | 7.8 ± 0.5 |
| std. dev. (μm) | | | | | | | | | |
| Density (kg/m³) | 545 | 397 | 274 | 150 | 300 | 340 | 430 | 470 | 940 |
| Porosity (%) | 53 | 65 | 76 | 87 | 74 | 70 | 62 | 59 | 17 |

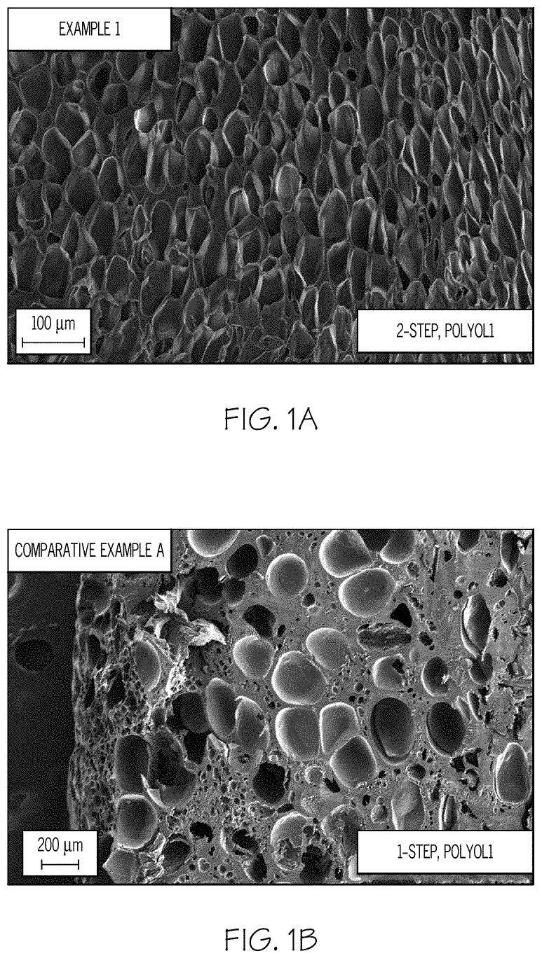

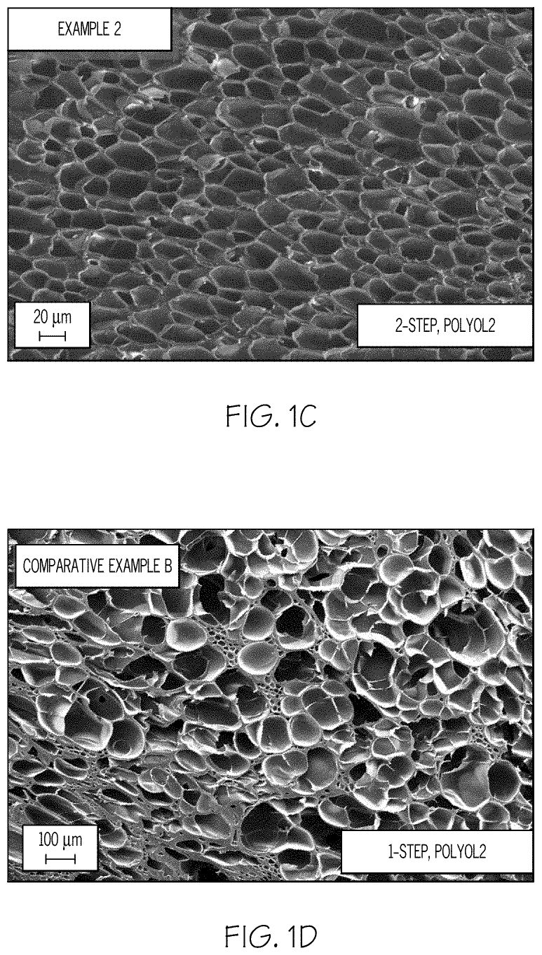

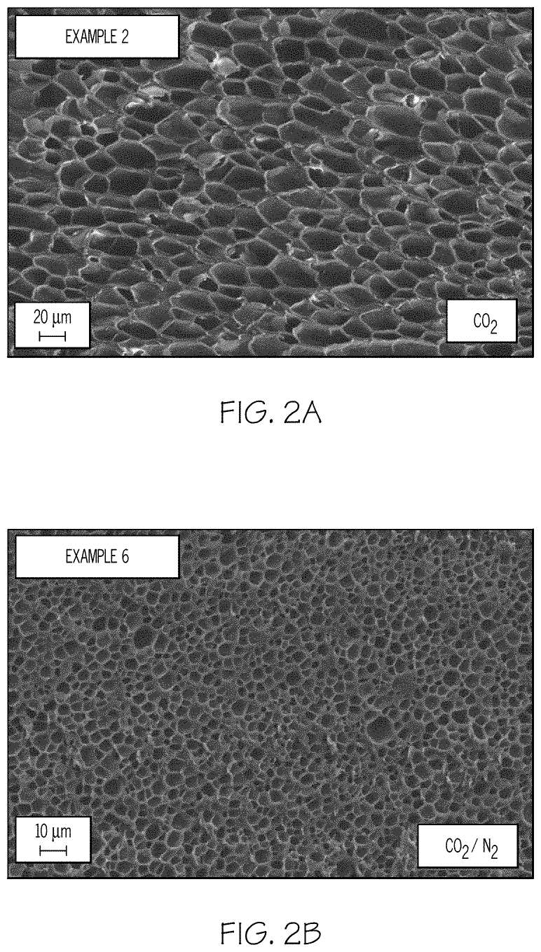

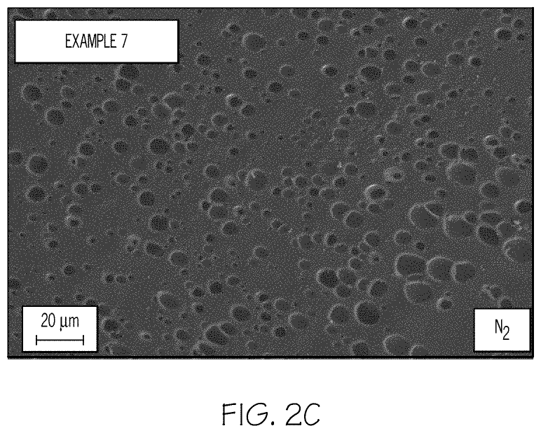

As shown in Table 3, the comparison of Comparative Example A and Comparative Example B with Example 1 and Example 2, respectively, show the effect of the use of two depressurization steps (Examples 1 and 2) instead of a single depressurization step (Comparative Examples A and B). FIGS. 1A-1D includes SEM images of Examples 1 (FIG. 1A) and 2 (FIG. 1C) and Comparative Examples A (FIG. 1B) and B (FIG. 1D). In particular, Examples 1 and 2 reached a uniform cell distribution in the range of 15 μm to 30 μm with a density varying from 150 kg/m³ to 274 kg/m³. This in contrast to Comparative Examples A and B, in which the one-step step depressurization generated bi-modal cell size distribution with cell size in the range of 56 μm to 200 μm with a density varying from 397 kg/m³ to 545 kg/m³. Accordingly, the use of a two-step depressurization resulted in uniform cell distribution, smaller cell size, and a lower density. Moreover, Examples 1 and 2 demonstrated that the two-step depressurization is applicable for various chemistries, and results in different cell sizes, densities, and porosities, suggesting that the properties of the polyurethane foam can be tuned by changing the polyols and process parameters depending on the particular embodiment.

Additionally, as demonstrated by Examples 2-5, the time t₁ can be selected to balance polyurethane cure time and expansion of the polymer. In particular, when t₁ was increased, the resultant foam was more compact (e.g., density increases and porosity decreases) until a complete vitrification process occurs (Example 5). Accordingly, these examples suggest that the polyurethane curing process can be tuned by selecting a particular depressurization timing t₁, and adapting the process to different cure profiles.

A comparison of Examples 2, 6, and 7 illustrate that the process can be carried out using a variety of different blowing agents with low GWP and no ODP. In particular, Example 2 employed a CO₂ blowing agent, Example 6 employed a blend of N₂ and CO₂ (80/20) as a blowing agent, and Example 7 employed N₂ as a blowing agent. As shown in the SEM images of FIG. 2A-2C, different foam morphologies may be obtained by utilizing different blowing agents. Although various properties of the foams of Examples 6 (FIG. 2B) and 7 (FIG. 2C) differed from the properties described hereinabove, these examples demonstrate the versatility of the process and indicate that the process is independent of the particular blowing agent employed.

Following the laboratory testing, Examples 8 and 9 were prepared using high pressure dosing-dispensing machines from Afros-Cannon. The process conditions for preparing the foams and foam properties are provided in Table 4 below. After the polyurethane components were mixed, the mixture was injected into a cavity/mold (e.g., refrigerator door), and the pressure was released. Thermal conductivity was measured under vacuum conditions using the hot disk method. Open cell content was measured according to ASTM D6226. The results are reported in Table 4.

TABLE 4
Table 4: Foam Formulations, Processing
Conditions, and Properties

| | Ex. 8 | Ex. 9 |
|---|---|---|
| Polyol 2 | 100 | 100 |
| VORACOR™ CR 761 | 72 | 97 |
| Blowing Agent | CO₂ | CO₂ |
| pₛₒᵣₚ (bar) | 100 | 100 |
| tₛₒᵣₚ (hr) | 20 | 20 |
| pₛₐₜ (bar) | 3.1 | 3.1 |
| p₁ (bar) | 160 | 160 |
| t₁ (min) | 0 | 0 |
| p₂ (bar) | 3 | 3 |
| t₂ (min) | 0.25 | 0.25 |
| Pressure drop rate | 5 | 5 |
| (bar/min) | | |
| Cell size, ave. ± std. | 104 ± 64 | 207 ± 93 |
| dev. (μm) | | |
| Density (kg/m³) | 80 | 59 |
| Porosity (%) | 93 | 95 |
| Thermal Conductivity | 17 mW/m-K | 12 mW/m-K |
| (mW/m-K) at internal | @ 1 mbar | @ 1 mbar |
| cell pressure (mbar) | | |
| Open Cell (%) | 90 | 80 |

Examples 8 and 9 were obtained using a two-step depressurization process at a pilot plant level. In particular, the foams were molded directly into a commercial refrigerator door mold, and demonstrate the feasibility of the process at the industrial level. Moreover, the examples enabled the measurement of thermal conductivity values which were below 18 mW/m-K.

Accordingly, various embodiments herein provide a process for producing a polyurethane foam that enable the use of an environmentally-friendly blowing agent, such as CO₂, N₂, or blends thereof, while enabling fine-tuning of the properties of the resultant foam. Such fine tuning may be employed to achieve polyurethane foams having a thermal conductivity of less than 18 mW/m-K, a density of less than or equal to 450 kg/m³, and/or a porosity of at least 70%.

It is further noted that terms like “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present disclosure.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A process for producing a polyurethane foam, comprising:
mixing a physical blowing agent with one or more of an isocyanate-reacting mixture and an isocyanate at a sorption pressure pₛₒᵣₚ for a time tₛₒᵣₚ;
reacting the isocyanate-reacting mixture and the isocyanate at a pressure p₁ for a time t₁;
reducing the pressure to a pressure p₂;
maintaining the pressure at the pressure p₂ for a time t₂; and
reducing the pressure to atmospheric pressure pₐₜₘ; wherein:
pₐₜₘ<p₂<pₛₐₜ<Pₛₒᵣₚ, where pₛₐₜ is a saturation pressure for the physical blowing agent; and
pₛₐₜ<p₁.

2. The process of claim 1, wherein the physical blowing agent further comprises CO₂, N₂, or one or more linear, branched, or cyclic alkanes or fluoroalkanes having 1-6 carbons.

3. The process of claim 1, wherein pₛₒᵣₚ is greater than or equal to 1 bar and less than or equal to 200 bar.

4. The process of claim 1, wherein pₛₐₜ is greater than 2 bar and less than or equal to 50 bar.

5. The process of claim 1, wherein p₁=pₛₒᵣₚ.

6. The process of claim 1, wherein p₂ is greater than 2.5 bar and less than or equal to 50 bar.

7. The process of claim 1, wherein reducing the pressure to the pressure p₂ is performed at a rate of from 500 bar/s to 5,000 bar/s.

8. The process of claim 1, wherein reducing the pressure to atmospheric pressure pₐₜₘ is performed at a rate of from 0.5 bar/min to 10 bar/min.

9. The process of claim 1, wherein the time t₁ is greater than or equal to 0.1 minute and less than or equal to 60 minutes.

10. The process of claim 1, wherein the time t₂ is greater than or equal to 0.1 minute and less than or equal to 60 minutes.

11. The process of claim 1, wherein the physical blowing agent comprises at least 80% CO₂.

12. The process of claim 1, wherein the polyurethane foam is a cellular foam having a density less than 450 kg/m³ and a porosity of at least 70%.

13. The process of claim 1, wherein the polyurethane foam has a thermal conductivity of less than or equal to 18 mW/m-K.

14. The process of claim 13, wherein the polyurethane foam has a nano- or microcellular structure.

15. A polyurethane foam produced by the process of claim 1.
